(19) United States
(12) Patent Application Publication
(10) Pub. No.: US 2024/0160273 A1
(43) Pub. Date: May 16, 2024

(54) INFERRING VR BODY MOVEMENTS INCLUDING VR TORSO TRANSLATIONAL MOVEMENTS FROM FOOT SENSORS ON A PERSON WHOSE FEET CAN MOVE BUT WHOSE TORSO IS STATIONARY

(71) Applicant: Sony Interactive Entertainment Inc., Tokyo (JP)

(72) Inventor: Sergey Bashkirov, San Mateo, CA (US)

(21) Appl. No.: 18/056,148

(22) Filed: Nov. 16, 2022

(51) Int. Cl. G06F 3/01; A63F 13/211; G02B 27/01

(52) U.S. Cl. CPC G06F 3/011; A63F 13/211; G02B 27/017; A63F 2300/8082

(57) ABSTRACT

Respective pose and motion sensors are engaged with the left and right feet of a sitting person and signals from the sensors are used to control the motion of a VR object presented on, e.g., a head-mounted display worn by the person. The sensor signals can be mapped to translational, rotational, and elevational motion of the VR object, and/or can be used to select controls to send controller-like signals to the game engine to control the VR object.

### FIELD

The present application relates generally to inferring VR body movements including VR torso movements from foot sensors on a person whose feet can move but whose torso is stationary.

### BACKGROUND

As understood herein, images of a person moving in the real world can be captured and used to create a virtual reality (VR) depiction of a computer graphic (CG) object moving to mimic the real-world person's movements.

### SUMMARY

As further understood herein, for various reasons a person may wish to remain stationary such as seated (or suspended by a harness) while moving his or her feet to control motion of a corresponding VR object, and/or to operate virtual controls. For instance, by remaining seated, a person can play a VR computer simulation such as a computer game in a small play area, protect the VR cable from the headset, use natural leg movements, and ameliorate motion sickness. Furthermore, locomotion in virtual reality in open world-like games where the virtual space is vastly bigger than any real-world play area a reasonable person may reserve for VR entertainment poses difficulties.

Accordingly, an apparatus includes at least one processor configured to receive signals from first and second motion sensors respectively mounted on left and right feet of a person whose torso is translationally stationary, and animate at least one virtual reality (VR) object on at least one display to move translationally according to the signals.

In some examples the instructions may be executable to animate the VR object to move rotationally according to the signals. Also, the instructions can be executable to animate the VR object to move elevationally according to the signals.

The signals from the motion sensors may represent pose and motion of the respective feet.

In non-limiting embodiments the instructions can be executable to animate the VR object to execute a jump according to the signals indicating an elevation change of both feet and a velocity of both feet, and otherwise not animate the VR object to execute a jump.

In non-limiting embodiments the instructions can be executable to animate the VR object to move opposite to motion of the left foot according to the signals indicating that the left foot is in contact with a surface and the right foot is not in contact with the surface.

In non-limiting embodiments the instructions can be executable to, responsive to the signals indicating both feet are in contact with a surface, animate the VR object to move at least in part based on a midpoint between the feet and a sum of at least a left foot displacement and a right foot displacement as indicated by the signals.

In another aspect, a device includes at least one computer storage that is not a transitory signal and that in turn includes instructions executable by at least one processor to receive signals from first and second motion sensors respectively mounted on left and right feet of a person whose torso is translationally stationary. The instructions are executable to correlate the signals to control elements for a computer simulation, and control at least one virtual reality (VR) object on at least one display according to the control elements correlated to the signals.

In some embodiments the control elements include control elements defined by a computer simulation controller. The control elements can include elongated sliders.

In example implementations the instructions may be executable to present the control elements on at least one display. If desired, the instructions may be executable to present representations of the feet of the person on the display. The display can include a head-mounted display.

In other examples, images of the control elements can be presented on a real-world substrate adjacent the feet of the person.

In another aspect, a method includes executing at least one of “A” or “B”. “A” includes receiving signals from first and second motion sensors respectively mounted on left and right feet of a person whose torso is translationally stationary, and animating at least one virtual reality (VR) object on at least one display to move translationally according to the signals. “B”, on the other hand, includes receiving signals from first and second motion sensors respectively mounted on left and right feet of a person whose torso is translationally stationary, correlating the signals to control elements for a computer simulation, and controlling at least one virtual reality (VR) object on at least one display according to the control elements correlated to the signals.

The details of the present application, both as to its structure and operation, can be best understood in reference to the accompanying drawings, in which like reference numerals refer to like parts, and in which:

### BRIEF DESCRIPTION OF THE DRAWINGS

FIG. 1 is a block diagram of an example system in accordance with present principles;

FIG. 2 illustrates an example specific system consistent with present principles;

FIG. 3 illustrates first example overall logic in example flow chart format;

FIG. 4 illustrates second example overall logic in example flow chart format;

FIG. 5 illustrates a person's feet with respective sensors with one foot moving translationally forward;

FIG. 5A illustrates a screen shot illustrating a VR object being controlled consistent with FIG. 5;

FIG. 6 illustrates the person's feet with respective sensors with one foot rotating;

FIG. 7 illustrates a screen shot illustrating a VR object being controlled consistent with FIG. 6;

FIG. 8 illustrates the person's feet with respective sensors with one or both feet being raised;

FIG. 9 illustrates a screen shot illustrating a VR object being controlled consistent with FIG. 8;

FIG. 10 illustrates a floor on which the player can move his or her feet, with button control regions;

FIG. 11 illustrates a floor on which the player can move his or her feet, with slider control regions;

FIG. 12 illustrates a screen shot illustrating a VR object being controlled consistent with FIG. 11;

FIG. 13 illustrates an example screen shot of a display such as the head-mounted display of FIG. 2 illustrating virtual indications to a user of control regions near the feet; and

FIG. 14 illustrates example specific logic in example flow chart format for processing signals from the foot-mounted sensors.

### DETAILED DESCRIPTION

This disclosure relates generally to computer ecosystems including aspects of consumer electronics (CE) device networks such as but not limited to computer game networks. A system herein may include server and client components which may be connected over a network such that data may be exchanged between the client and server components. The client components may include one or more computing devices including game consoles such as Sony PlayStation® or a game console made by Microsoft or Nintendo or other manufacturer, extended reality (XR) headsets such as virtual reality (VR) headsets, augmented reality (AR) headsets, portable televisions (e.g., smart TVs, Internet-enabled TVs), portable computers such as laptops and tablet computers, and other mobile devices including smart phones and additional examples discussed below. These client devices may operate with a variety of operating environments. For example, some of the client computers may employ, as examples, Linux operating systems, operating systems from Microsoft, or a Unix operating system, or operating systems produced by Apple, Inc., or Google, or a Berkeley Software Distribution or Berkeley Standard Distribution (BSD) OS including descendants of BSD. These operating environments may be used to execute one or more browsing programs, such as a browser made by Microsoft or Google or Mozilla or other browser program that can access websites hosted by the Internet servers discussed below. Also, an operating environment according to present principles may be used to execute one or more computer game programs.

Servers and/or gateways may be used that may include one or more processors executing instructions that configure the servers to receive and transmit data over a network such as the Internet. Or a client and server can be connected over a local intranet or a virtual private network. A server or controller may be instantiated by a game console such as a Sony PlayStation®, a personal computer, etc.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website or gamer network to network members.

A processor may be a single- or multi-chip processor that can execute logic by means of various lines such as address lines, data lines, and control lines and registers and shift registers. A processor including a digital signal processor (DSP) may be an embodiment of circuitry.

Components included in one embodiment can be used in other embodiments in any appropriate combination. For example, any of the various components described herein and/or depicted in the Figures may be combined, interchanged, or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together.

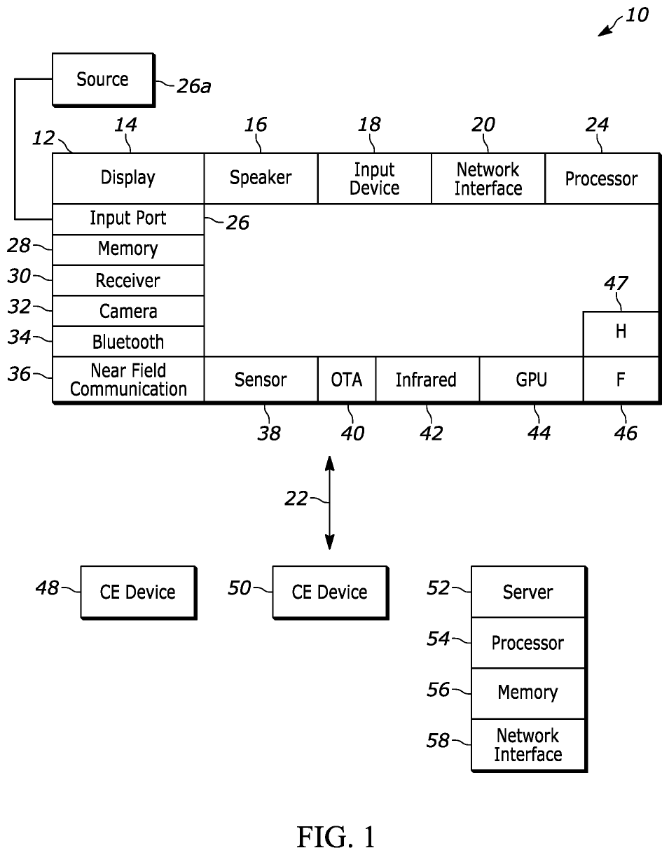

Referring now to FIG. 1, an example system 10 is shown, which may include one or more of the example devices mentioned above and described further below in accordance with present principles. The first of the example devices included in the system 10 is a consumer electronics (CE) device such as an audio video device (AVD) 12 such as but not limited to a theater display system which may be projector-based, or an Internet-enabled TV with a TV tuner (equivalently, set top box controlling a TV). The AVD 12 alternatively may also be a computerized Internet enabled (“smart”) telephone, a tablet computer, a notebook computer, a head-mounted device (HMD) and/or headset such as smart glasses or a VR headset, another wearable computerized device, a computerized Internet-enabled music player, computerized Internet-enabled headphones, a computerized Internet-enabled implantable device such as an implantable skin device, etc. Regardless, it is to be understood that the AVD 12 is configured to undertake present principles (e.g., communicate with other CE devices to undertake present principles, execute the logic described herein, and perform any other functions and/or operations described herein).

Accordingly, to undertake such principles the AVD 12 can be established by some, or all of the components shown. For example, the AVD 12 can include one or more touch-enabled displays 14 that may be implemented by a high definition or ultra-high definition “4K” or higher flat screen. The touch-enabled display(s) 14 may include, for example, a capacitive or resistive touch sensing layer with a grid of electrodes for touch sensing consistent with present principles.

The AVD 12 may also include one or more speakers 16 for outputting audio in accordance with present principles, and at least one additional input device 18 such as an audio receiver/microphone for entering audible commands to the AVD 12 to control the AVD 12. The example AVD 12 may also include one or more network interfaces 20 for communication over at least one network 22 such as the Internet, an WAN, an LAN, etc. under control of one or more processors 24. Thus, the interface 20 may be, without limitation, a Wi-Fi transceiver, which is an example of a wireless computer network interface, such as but not limited to a mesh network transceiver. It is to be understood that the processor 24 controls the AVD 12 to undertake present principles, including the other elements of the AVD 12 described herein such as controlling the display 14 to present images thereon and receiving input therefrom. Furthermore, note the network interface 20 may be a wired or wireless modem or router, or other appropriate interface such as a wireless telephony transceiver, or Wi-Fi transceiver as mentioned above, etc.

In addition to the foregoing, the AVD 12 may also include one or more input and/or output ports 26 such as a high-definition multimedia interface (HDMI) port or a universal serial bus (USB) port to physically connect to another CE device and/or a headphone port to connect headphones to the AVD 12 for presentation of audio from the AVD 12 to a user through the headphones. For example, the input port 26 may be connected via wire or wirelessly to a cable or satellite source 26a of audio video content. Thus, the source 26a may be a separate or integrated set top box, or a satellite receiver. Or the source 26a may be a game console or disk player containing content. The source 26a when implemented as a game console may include some or all of the components described below in relation to the CE device 48.

The AVD 12 may further include one or more computer memories/computer-readable storage media 28 such as disk-based or solid-state storage that are not transitory signals, in some cases embodied in the chassis of the AVD as standalone devices or as a personal video recording device (PVR) or video disk player either internal or external to the chassis of the AVD for playing back AV programs or as removable memory media or the below-described server. Also, in some embodiments, the AVD 12 can include a position or location receiver such as but not limited to a cellphone receiver, GPS receiver and/or altimeter 30 that is configured to receive geographic position information from a satellite or cellphone base station and provide the information to the processor 24 and/or determine an altitude at which the AVD 12 is disposed in conjunction with the processor 24.

Continuing the description of the AVD 12, in some embodiments the AVD 12 may include one or more cameras 32 that may be a thermal imaging camera, a digital camera such as a webcam, an IR sensor, an event-based sensor, and/or a camera integrated into the AVD 12 and controllable by the processor 24 to gather pictures/images and/or video in accordance with present principles. Also included on the AVD 12 may be a Bluetooth® transceiver 34 and other Near Field Communication (NFC) element 36 for communication with other devices using Bluetooth and/or NFC technology, respectively. An example NFC element can be a radio frequency identification (RFID) element.

Further still, the AVD 12 may include one or more auxiliary sensors 38 that provide input to the processor 24. For example, one or more of the auxiliary sensors 38 may include one or more pressure sensors forming a layer of the touch-enabled display 14 itself and may be, without limitation, piezoelectric pressure sensors, capacitive pressure sensors, piezoresistive strain gauges, optical pressure sensors, electromagnetic pressure sensors, etc. Other sensor examples include a pressure sensor, a motion sensor such as an accelerometer, gyroscope, cyclometer, or a magnetic sensor, an infrared (IR) sensor, an optical sensor, a speed and/or cadence sensor, an event-based sensor, a gesture sensor (e.g., for sensing gesture command). The sensor 38 thus may be implemented by one or more motion sensors, such as individual accelerometers, gyroscopes, and magnetometers and/or an inertial measurement unit (IMU) that typically includes a combination of accelerometers, gyroscopes, and magnetometers to determine the location and orientation of the AVD 12 in three dimension or by an event-based sensors such as event detection sensors (EDS). An EDS consistent with the present disclosure provides an output that indicates a change in light intensity sensed by at least one pixel of a light sensing array. For example, if the light sensed by a pixel is decreasing, the output of the EDS may be −1; if it is increasing, the output of the EDS may be a +1. No change in light intensity below a certain threshold may be indicated by an output binary signal of 0.

The AVD 12 may also include an over-the-air TV broadcast port 40 for receiving OTA TV broadcasts providing input to the processor 24. In addition to the foregoing, it is noted that the AVD 12 may also include an infrared (IR) transmitter and/or IR receiver and/or IR transceiver 42 such as an IR data association (IRDA) device. A battery (not shown) may be provided for powering the AVD 12, as may be a kinetic energy harvester that may turn kinetic energy into power to charge the battery and/or power the AVD 12. A graphics processing unit (GPU) 44 and field programmable gated array 46 also may be included. One or more haptics/vibration generators 47 may be provided for generating tactile signals that can be sensed by a person holding or in contact with the device. The haptics generators 47 may thus vibrate all or part of the AVD 12 using an electric motor connected to an off-center and/or off-balanced weight via the motor's rotatable shaft so that the shaft may rotate under control of the motor (which in turn may be controlled by a processor such as the processor 24) to create vibration of various frequencies and/or amplitudes as well as force simulations in various directions.

A light source such as a projector such as an infrared (IR) projector also may be included.

In addition to the AVD 12, the system 10 may include one or more other CE device types. In one example, a first CE device 48 may be a computer game console that can be used to send computer game audio and video to the AVD 12 via commands sent directly to the AVD 12 and/or through the below-described server while a second CE device 50 may include similar components as the first CE device 48. In the example shown, the second CE device 50 may be configured as a computer game controller manipulated by a player or a head-mounted display (HMD) worn by a player. The HMD may include a heads-up transparent or non-transparent display for respectively presenting AR/MR content or VR content (more generally, extended reality (XR) content). The HMD may be configured as a glasses-type display or as a bulkier VR-type display vended by computer game equipment manufacturers.

In the example shown, only two CE devices are shown, it being understood that fewer or greater devices may be used. A device herein may implement some or all of the components shown for the AVD 12. Any of the components shown in the following figures may incorporate some or all of the components shown in the case of the AVD 12.

Now in reference to the aforementioned at least one server 52, it includes at least one server processor 54, at least one tangible computer readable storage medium 56 such as disk-based or solid-state storage, and at least one network interface 58 that, under control of the server processor 54, allows for communication with the other illustrated devices over the network 22, and indeed may facilitate communication between servers and client devices in accordance with present principles. Note that the network interface 58 may be, e.g., a wired or wireless modem or router, Wi-Fi transceiver, or other appropriate interface such as, e.g., a wireless telephony transceiver.

Accordingly, in some embodiments the server 52 may be an Internet server or an entire server “farm” and may include and perform “cloud” functions such that the devices of the system 10 may access a “cloud” environment via the server 52 in example embodiments for, e.g., network gaming applications. Or the server 52 may be implemented by one or more game consoles or other computers in the same room as the other devices shown or nearby.

The components shown in the following figures may include some or all components shown in herein. Any user interfaces (UI) described herein may be consolidated and/or expanded, and UI elements may be mixed and matched between UIs.

Present principles may employ various machine learning models, including deep learning models. Machine learning models consistent with present principles may use various algorithms trained in ways that include supervised learning, unsupervised learning, semi-supervised learning, reinforcement learning, feature learning, self-learning, and other forms of learning. Examples of such algorithms, which can be implemented by computer circuitry, include one or more neural networks, such as a convolutional neural network (CNN), a recurrent neural network (RNN), and a type of RNN known as a long short-term memory (LSTM) network. Support vector machines (SVM) and Bayesian networks also may be considered to be examples of machine learning models. In addition to the types of networks set forth above, models herein may be implemented by classifiers.

As understood herein, performing machine learning may therefore involve accessing and then training a model on training data to enable the model to process further data to make inferences. An artificial neural network/artificial intelligence model trained through machine learning may thus include an input layer, an output layer, and multiple hidden layers in between that that are configured and weighted to make inferences about an appropriate output.

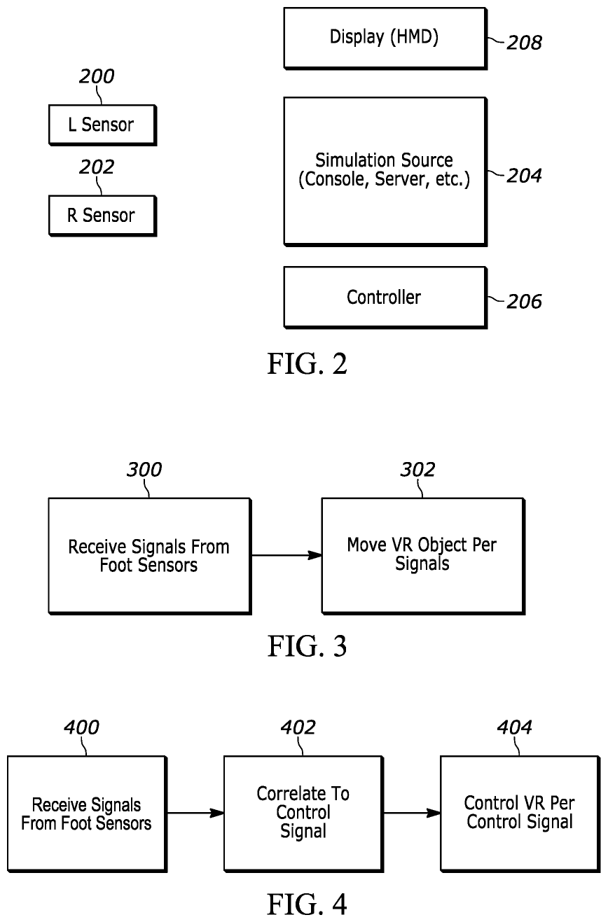

Refer now to FIG. 2. In one example, left and right sensors 200, 202 are provided on the feet of a person whose torso does not move translationally. For example, the person may be seated in a chair. Or, the person may be suspended by a harness or floating in water.

The sensors 200, 202 can be motion and pose sensors. The sensors 200, 202 may incorporate any of the sensors described herein as appropriate. It will be appreciated that the sensors 200, 202 output signals representing motion of the feet and/or pose of the feet.

The signals from the sensors 200, 202 are sent via wired and/or wireless paths to a source 204 of computer simulations such as computer games. The source 204 may be, e.g., a computer game console or a streaming computer game server. A hand-held computer simulation controller 206 may be used to input commands to the source 204 to control play of a computer simulation such as a computer game which may be presented on a display 208, such as a head-mounted display worn by the person whose feet sport the sensors 200, 202.

FIG. 3 illustrates first overall logic that may be implemented by any one or more computer processors herein accessing instructions contained on any one or more computer storage devices herein. Commencing at block 300, signals are received from the foot sensors 200, 202. Moving to block 302, a virtual reality (VR) object in a computer simulation is animated to move consistent with the signals. Thus, for example, if a sitting user slides his feet forward, the VR object is animated to move forward. If a sitting user turns his left foot, the VR object is animated to turn to the left. If a sitting user turns his right foot, the VR object is animated to turn to the right. If a sitting user rapidly lifts both feet as if jumping, the VR object is animated to jump upward. If a sitting user slides his feet backward, the VR object is animated to move backward. Acceleration and steering or VR objects also may be controlled using acceleration/velocity components of the signals from the foot sensors.

FIG. 4 illustrates second overall logic that may be implemented by any one or more computer processors herein accessing instructions contained on any one or more computer storage devices herein. Commencing at block 400, signals are received from the foot sensors 200, 202. Moving to block 402, the signals from the foot sensors are correlated to control signals. As discussed in greater depth herein, this may be done by correlating foot position to virtual positions of control elements the functions of which may be defined by the simulation controller, i.e., the person may move his feet to “select” a control element as if manipulating the computer simulation controller 206, for example. Proceeding to block 404, the computer simulation is controller per the control signals.

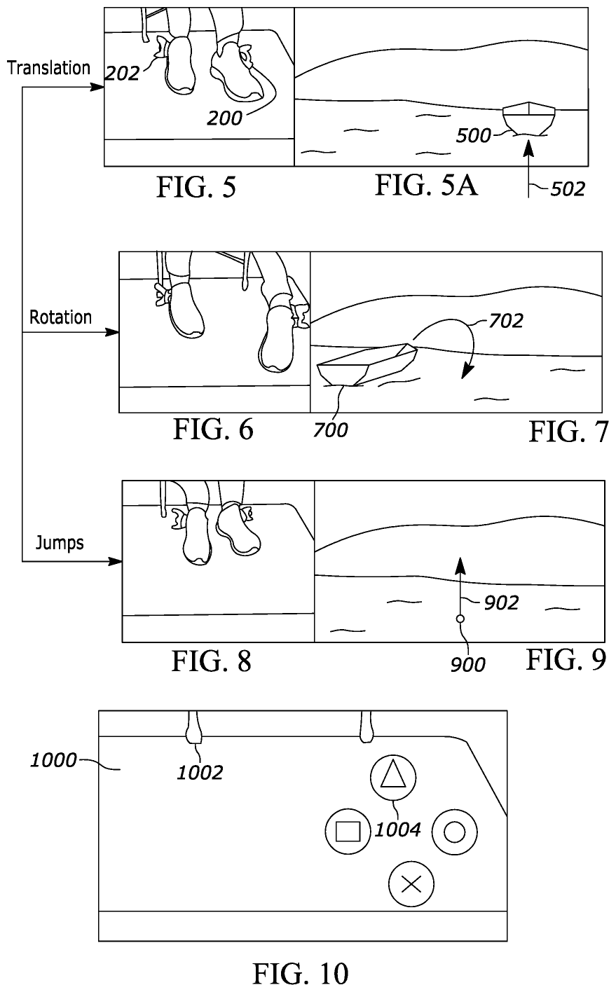

FIGS. 5-9 illustrate principles consistent with FIG. 3. Disclosure herein generally refers to the two orthogonal horizontal dimensions as “x” (side-to-side or, anatomically, from medial to lateral relative to the person) and “z” (forward and backward or, anatomically, from posterior to anterior relative to the person) and the vertical dimension as “y”.

In FIG. 5, a sitting person has moved his left foot and, hence, the left foot sensor 200 shown in FIG. 2 forward, in the “z” dimension. FIG. 5A illustrates that in response, a VR object 500 is animated to move forward as shown by the arrow 502.

In FIG. 6, a sitting person has rotated his left foot forward and right and, hence, the left foot sensor 200 shown in FIG. 2 forward and right, about the “y” axis and in the “z” dimension. FIG. 7 illustrates that in response, a VR object 700 is animated to move forward and to turn right as shown by the arrow 702.

In FIG. 8, a sitting person has lifted both feet and, hence, both foot sensors 200, 202 shown in FIG. 2 upward as if jumping in the “y” dimension. FIG. 9 illustrates that in response, a VR object 900 is animated to move upward as if jumping as shown by the arrow 902.

FIGS. 10-13 illustrate principles consistent with FIG. 4. FIG. 10 illustrates a substrate 1000 above which a chair 1002 is located on which a person can sit and move his feet relative to the substrate. Visible indicia 1004 representing computer simulation control elements may be presented on the substrate so that the person can guide his or her feet onto a control element to input, as a game command, the function associated with the selected control element. The control elements indicated by the visible indicia 1004 may be control elements whose functions are defined by corresponding control elements on the controller 206 shown in FIG. 2, in the example shown, the triangle, square, circle, and “X” keys of a PlayStation controller.

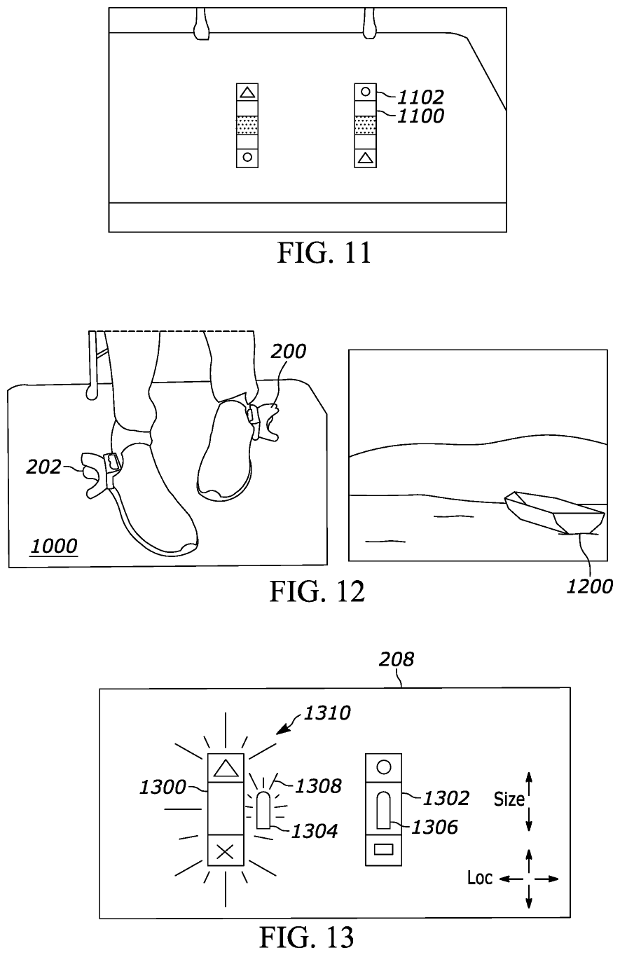

In FIG. 11, a sitting person is moving his feet on a physical substrate 1000 on which, as shown in Figure, may be visible representations of control elements 1100 such as elongated control elements or sliders having at their ends visible indicia 1102 of further control elements. The control elements indicated by the visible indicia 1102 may be control elements whose functions are defined by corresponding control elements on the controller 206 shown in FIG. 2, in the example shown, the triangle, square, circle, and “X” keys of a PlayStation controller. As the person moves his feet, the movements are indicated by signals from the sensors 200 202 to correlate sensor position (and hence foot position) to be adjacent a control element. The function of the adjacent control element is input to a computer simulation as a command to control, e.g., a VR object 1200 (FIG. 12) according to the command.

In addition, or alternatively, FIG. 13 illustrates a display such as the HMD 208 shown in FIG. 2 on which images of left and right control elements 1300, 1302 may be presented along with avatars 1304, 1306 representing the locations of the respective left and right feet. In this way, the person who is seated wearing an HMD can visually see where his feet are in relation to the control elements. In the example of FIG. 13, the right foot avatar 1306 is shown on the slider established by the right control 1302. The person accordingly can slide his right foot forward to cause the VR object 1200 to move translationally forward. The person also can move his foot over one of the control elements 1102 and place his foot down on it to “select” the corresponding function to generate a simulation control command which is input to the game engine.

On the other hand, FIG. 13 illustrates that the left foot is not on the control element by illustrating the left foot avatar 1304 as being distanced laterally to the right from the left control element 1300. To help the person better understand this, either the left foot avatar 1304 and/or left control element 1300 may be highlighted or blinked or otherwise made visibly more salient as indicated by the salience symbols 1308 (for the foot avatar) and 1310 (for the control element).

If desired, size and location controls 1312 may be presented on the display 208 that can be selected by the person to increase or decrease size of display objects and to move the control elements 1300, 1302 on the display.

If the landing point of a foot is sufficiently close to a control element or slider, it may be assumed to be on the slider. Voronoi decomposition may be used for this purpose.

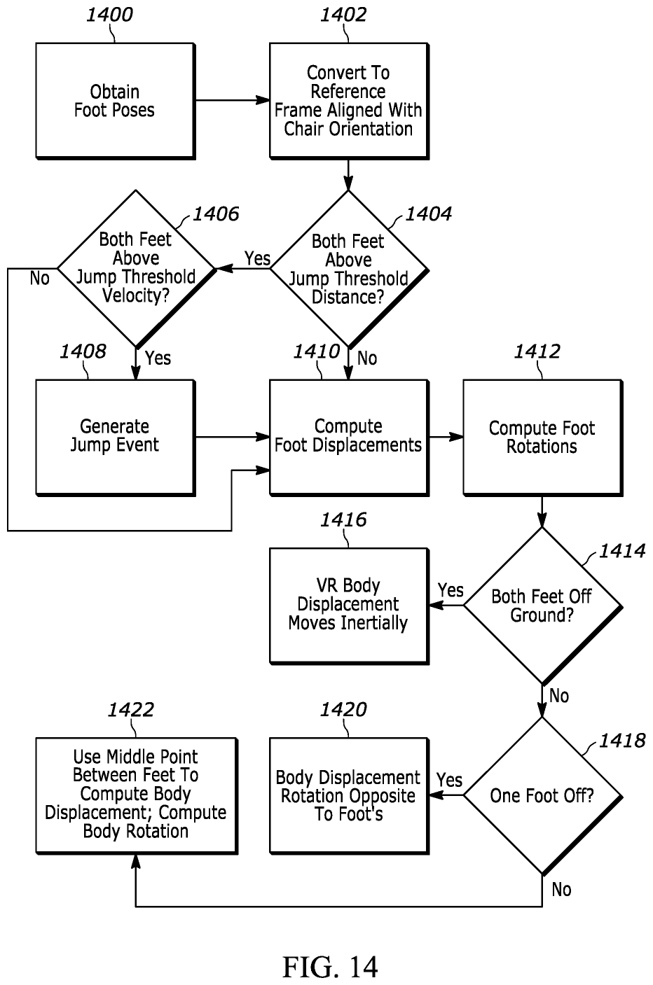

FIG. 14 illustrates an example specific logic for correlating foot sensor signals to VR object motion. Commencing at block 1400, left and right foot poses (position, orientation) are obtained from the signals from the foot sensors. At block 1402 the poses are converted to the reference frame aligned with the chair orientation.

Moving to decision diamonds 1404 and 1406, if it is determined from the signals from the foot sensors that both feet have been lifted off the ground above a threshold distance (1404) at a rate above a threshold rate (1406), a jump event is generated at block 1408 to cause a VR object to be animated to execute a vertical jump. If either foot does not meet either test in states 1404 and 1406, no jump is executed.

Whether a jump is executed or not, the logic may proceed to block 1410 to compute feet position displacements compared to the positions at previous interval (in the game world, at the previous video frame). Also, at block 1412 the logic computes feet rotation component around the vertical (“y”) axis compared to the previous frame.

Moving to decision diamond 1414, it is determined whether both feet are off the ground. If the feet are not in contact with the ground, the body origin displacement Δr\vec{ } is modeled to moves in inertial way at block 1416 subjected to gravity, i.e., Δr\vec{ }=v\vec{ }Δt+g\vec{ }Δt²/2, where “v” is body velocity, Δt is the time period since the last measurement, and “g” is the vector representing free fall acceleration.

If only one but not both feet are determined to be on the ground at decision diamond 1418, the logic moves to block 1420 to determine body displacement and rotation to be the opposite to the displacement and rotation of the foot in contact with the ground.

In contrast, if it is determined that both feet are on the ground, the displacement of a position of a middle point between the two feet is used to compute the body displacement as being the same displacement but opposite in direction to the displacement of the middle point between the feet. The body's rotation is computed to be the sum of three foot rotational components about the “y” axis, namely, is the sum of the negatives of the left foot rotational displacement, the right foot rotational displacement, and a value (aₗᵢₙₑ) given by an atan 2 function with arguments being the two horizontal coordinates: aₗᵢₙₑ=atan 2(z, x), where “z” is the dot product of the projection of the “z” vector of the foot sensor's reference frame onto the x, z plane of the chair reference frame and the x vector of the chair's reference frame, and “x” is the dot product of the projection of the “z” vector of the foot sensor's reference frame onto the x, z plane of the chair reference frame and the z vector of the chair's reference frame.

In a non-limiting example, the foot sensor's reference frame can be correlated to the chair reference frame using a transformation. At least three positions of the feet are first recorded, namely, a) neutral, b) both feet are in front of the neutral position; c) left foot is on the left and right foot is on the right with respect to the neutral position. These initial feet positions establish the reference frame of the chair.

Then matrices are composed for left and right foot trackers. Matrix columns consist of normalized right, up, and back vector (x, y, z) components. The matrices are inverted to get transformations in the reference frame aligned with the chair position.

While the particular embodiments are herein shown and described in detail, it is to be understood that the subject matter which is encompassed by the present invention is limited only by the claims.

1. An apparatus comprising:
at least one processor configured to:
receive signals from first and second motion sensors respectively mounted on left and right feet of a person whose torso is translationally stationary; and
animate at least one virtual reality (VR) object on at least one display to move translationally according to the signals.

2. The apparatus of claim 1, wherein the instructions are executable to animate the VR object to move rotationally according to the signals.

3. The apparatus of claim 1, wherein the instructions are executable to animate the VR object to move elevationally according to the signals.

4. The apparatus of claim 1, wherein the signals from the motion sensors represent pose and motion of the respective feet.

5. The apparatus of claim 1, wherein the instructions are executable to animate the VR object to execute a jump according to the signals indicating an elevation change of both feet and a velocity of both feet, and otherwise not animate the VR object to execute a jump.

6. The apparatus of claim 1, wherein the instructions are executable to animate the VR object to move opposite to motion of the left foot according to the signals indicating that the left foot is in contact with a surface and the right foot is not in contact with the surface.

7. The apparatus of claim 1, wherein the instructions are executable to, responsive to the signals indicating both feet are in contact with a surface, animate the VR object to move at least in part based on a midpoint between the feet and a sum of at least a left foot displacement and a right foot displacement as indicated by the signals.

8. A device comprising:
at least one computer storage that is not a transitory signal and that comprises instructions executable by at least one processor to:
receive signals from first and second motion sensors respectively mounted on left and right feet of a person whose torso is translationally stationary;
correlate the signals to control elements for a computer simulation; and
control at least one virtual reality (VR) object on at least one display according to the control elements correlated to the signals.

9. The device of claim 8, wherein the control elements comprise control elements defined by a computer simulation controller.

10. The device of claim 8, wherein the control elements comprise elongated sliders.

11. The device of claim 8, wherein the instructions are executable to present the control elements on at least one display.

12. The device of claim 11, wherein the instructions are executable to present representations of the feet of the person on the at least one display.

13. The device of claim 12, wherein the at least one display comprises a head-mounted display.

14. The device of claim 8, wherein images of the control elements are presented on a real-world substrate adjacent the feet of the person.

15. A method comprising:
executing at least one of A or B, wherein:
A comprises:
receiving signals from first and second motion sensors respectively mounted on left and right feet of a person whose torso is translationally stationary; and
animating at least one virtual reality (VR) object on at least one display to move translationally according to the signals; and
B comprises:
receiving signals from first and second motion sensors respectively mounted on left and right feet of a person whose torso is translationally stationary;
correlating the signals to control elements for a computer simulation; and
controlling at least one virtual reality (VR) object on at least one display according to the control elements correlated to the signals.

16. The method of claim 15, comprising executing A.

17. The method of claim 15, comprising executing B.

18. The method of claim 15, comprising executing A and B.

19. The method of claim 16, wherein the signals from the motion sensors represent pose and motion of the respective feet.

20. The method of claim 17, wherein the control elements comprise control elements defined by a computer simulation controller.
